(19) United States
(12) Patent Application Publication
(10) Pub. No.: US 2009/0319997 A1
(43) Pub. Date: Dec. 24, 2009

(54) PRECONDITION RULES FOR STATIC VERIFICATION OF CODE

(75) Inventors: Jakob Frederik Lichtenberg, Seattle, WA (US); Conal McGarvey, Seattle, WA (US); Eleonora O. Bounimova, Redmond, WA (US); Vladimir A. Levin, Redmond, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/142,775

(22) Filed: Jun. 20, 2008

(51) Int. Cl. G06F 9/44

(52) U.S. Cl. 717/126

(57) ABSTRACT

A verification engine for verifying compliance of a module of computer-executable instructions to various specifications or guidelines can utilize precondition rules to obtain information about the module so as to select appropriate rules with which the module will be verified. The precondition rules can inform an evaluation tool, which can obtain the specified information about the module. A preprocessor can then evaluate conditional statements and select one or more rules or environment modules based on the results of the evaluation of the precondition rules. Multiple levels of dependent precondition rules can be evaluated with a drill-down approach, where each dependency chain is evaluated until a terminal level, or with a layered approach, where all terminal level precondition rules are evaluated followed by precondition rules of increasingly higher levels.

### BACKGROUND

To aid in the creation of computer programs and components of computer-executable instructions, various tools have been developed that seek to identify potential problems. One such set of tools is directed to the testing of computer programs and components by executing them under controlled circumstances and observing the results. The testing of computer-readable code seeks to examine the actual performance of the code when executed and identify any unexpected actions on the part of the code, or any unexpected results. Traditionally, such unexpected actions or results are referred to as “bugs” in the code. Once identified through testing, a targeted examination of the relevant computer-executable instructions can be undertaken to identify the cause of the unexpected actions or results and, hopefully, corrective measures can be identified and performed.

Another set of tools used to examine computer programs and components are verification tools that seek to analyze the computer-readable code itself, rather than its actual behavior. Such verification tools can identify issues in the code itself, such as failures to conform to guidelines regarding the expected behavior of the code, failures to conform to the specifications of the code's interaction with external elements, failures to adhere to specific coding conventions, or other similar issues. Verification tools often comprise a verification engine that can perform the actual verification, and one or more rules that can define or indicate the relevant expected behavior, specification of interaction with external elements, coding convention, or other issue that is to be verified. Often, the computer-readable code being verified may require some supporting structure. For example, the verification of a component may require at least some aspects of the other elements that component is designed to interact with, or the component may not be able to be verified properly. Such execution environment issues can be addressed by environmental models that can be associated with relevant rules and can be provided to the verification engine, or they may even be addressed by different types of verification engines themselves.

Traditionally, code verification tools sought to generate an abstraction of the computer program or component being verified, often in the form of a mathematical model. Such efforts can be non-linear and, as a result, depending on the complexity and quantity of the computer-readable code being verified, verification attempts can consume all available memory resources, or can otherwise take so long that, from a practical perspective, the verification attempt will not finish. Traditional solutions to such inefficiencies were directed to the verification engine itself, as a faster verification engine can improve the efficiency with which any computer-readable code, simple or complex, is verified.

### SUMMARY

Aspects of the verification of computer-executable instructions are often complex and multi-faceted. In particular, verification that computer-executable instructions conform to specific expected behaviors, specifications or coding conventions may be more easily conceptualized as multiple correlated verifications, each directed to a simpler issue. Code verification tools that can first check if certain conditions are met prior to verifying a particular set of computer-executable instructions, can avoid verifications that may be irrelevant to that particular set of computer-executable instructions, thereby increasing the efficiency of the overall verification process. In addition, code verification tools that can process an overall verification as a series of correlated verifications, each directed to a simpler issue, can render such verifications easier for human users to set up and can make it more likely that the verification will succeed.

In one embodiment, therefore, a verification system can accept the specification of “precondition rules” that can limit the circumstances in which particular verification rules are applied to a set of computer-executable instructions being verified. The precondition rules can obtain information regarding the computer-executable instructions being verified and, on the basis of the obtained information, a particular set of rules can be selected, or deselected, against which the computer-executable instructions can be verified.

In another embodiment, an environment model representing the computer-executable instructions which interact with the computer-executable instructions being verified can likewise be selected, or deselected, prior to verification based on the results from one or more precondition rules. The environment model can be associated with a particular rule, and can, thereby, be selected, or deselected, together with the associated rule, depending on the results of the evaluation of the precondition rules. Alternatively, a single rule can be applied to verify computer-executable instructions using any one of a multiple of different environment models and, in such a case, the environment model can be selected based on the precondition rules independently of the rule with which the computer-executable instructions are being verified.

In a further embodiment, the precondition rules can themselves comprise further precondition rules, such that some precondition rules either are, or are not, evaluated based on the results of precondition rules to those precondition rules. Such multiple layers of precondition rules can be evaluated using any of a multiple of evaluation mechanisms. In one embodiment, a “lazy” evaluation mechanism can examine a precondition rule to identify any precondition rules to that precondition rule. Such an examination can proceed until a terminal level of precondition rules is reached, at which point those precondition rules can be evaluated. Precondition rules dependent on those precondition rules can then be evaluated, and the evaluation can proceed in such a manner until the first level of precondition rules is reached, at which point, analysis can proceed to the next precondition rule at that level. In an alternative embodiment, an “eager” evaluation mechanism can examine some or all of the multiple levels of precondition rules and can categorize the precondition rules according to level. Subsequently, evaluation of the precondition rules at the terminal level can be performed, followed up evaluation of the precondition rules at the immediately higher level, and proceeding in such a manner until the precondition rules at the first level are evaluated. While such an evaluation mechanism can result in a simplified evaluation strategy, it can also result in the evaluation of precondition rules that end up being irrelevant for other reasons and can, thereby, introduce a measure of inefficiency.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Additional features and advantages will be made apparent from the following detailed description that proceeds with reference to the accompanying drawings.

### DESCRIPTION OF THE DRAWINGS

The following detailed description may be best understood when taken in conjunction with the accompanying drawings, of which:

FIG. 1 is a block diagram of an exemplary verification system;

FIG. 2 is a block diagram of an exemplary computing device; and

FIG. 3 is a block diagram of an exemplary verification system that can utilize precondition rules;

FIG. 4 is a block diagram of some of the files and components of an exemplary verification system that can utilize precondition rules;

FIG. 5 is an exemplary flow diagram for verifying computer-readable instructions with reference to precondition rules;

FIG. 6 is an exemplary flow diagram for evaluating precondition rules; and

FIG. 7 is another exemplary flow diagram for evaluating precondition rules.

### DETAILED DESCRIPTION

The following description relates to the verification of computer-executable instructions by first referencing precondition rules to inform the selection, or deselection of various verification mechanisms. Evaluation of the precondition rules can provide information regarding the computer-executable instructions to be verified, thereby enabling the selection of appropriate verification rules and environment models, and possibly even evaluation engines, and the deselection of inappropriate verification rules and environment models. Evaluation of the precondition rules can be performed using a “lazy” mechanism, whereby levels of precondition rules associated with one first level precondition rule are evaluated before levels of precondition rules associated with another first level precondition rule are evaluated, or the evaluation of precondition rules can be performed using an “eager” mechanism, whereby precondition rules are evaluated by level, commencing with a terminal level.

The techniques described herein focus on, but are not limited to, the utilization of precondition rules by a set of static verification tools, such as may be developed for, and provided to, a wide range of consumers. Indeed, the techniques described herein are equally applicable to customized verification solutions. As such, references to verification engines, environment models, rules, precondition rules, and modules are not meant to be limited to the particular examples described, but are instead intended to encompass any suitable such elements.

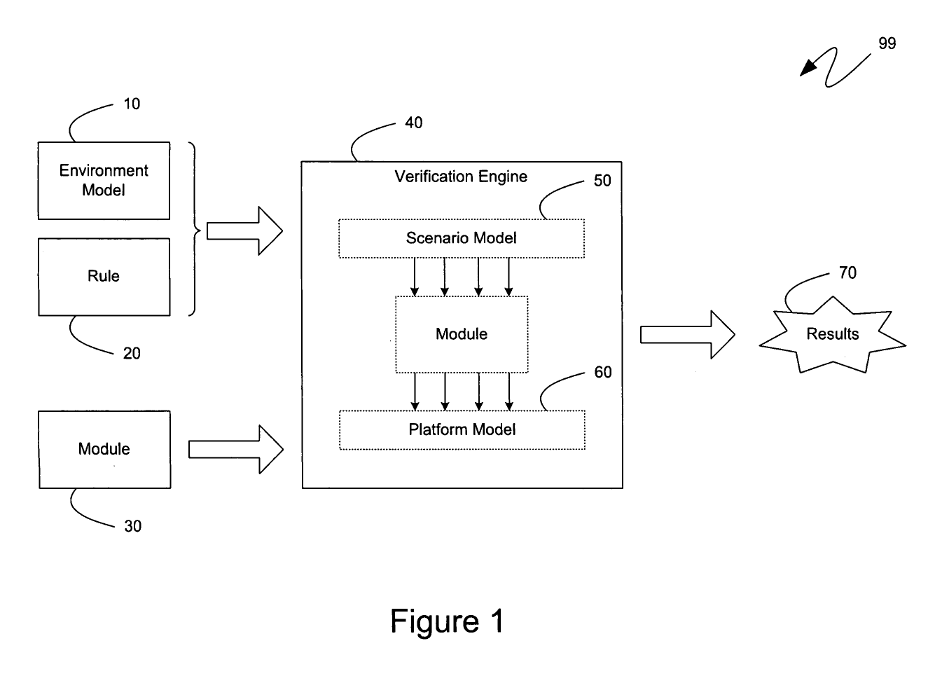

Turning to FIG. 1, an exemplary system 99 is illustrated comprising a verification engine 40, that can perform a verification of a module 30 with respect to a particular rule 20 and, if applicable, a particular environment model 10, to produce the verification results 70. The module 30 upon which the verification of system 99 can be performed can be either a complete application, or it can be a component of an application or operating system, or any other relevant segment of computer-executable instructions. For ease of reference, the term “module” will be used herein to refer to any such object that can be verified by the verification engine 40.

In some cases the verification of the module 30 by the verification engine 40 can utilize an abstraction of computer-executable instructions that can invoke the module, an abstraction of computer-executable instructions that can provide support for the module, or a combination thereof. For example, a peripheral device driver, such as would execute within the context of an operating system, may be verified with reference to function calls, such as would be made by a higher level application to invoke the peripheral device driver, and operating system support, such as would be provided to the peripheral device driver by the operating system in response to requests from the peripheral device driver.

For purposes of verification of the module 30 with respect to a particular rule 20, a scenario model 50 can abstract the relevant features and functionality of higher-level software applications or other computer-executable instructions that can invoke, or make requests of, the module. Similarly, for purposes of verification of the module 30 with respect to a particular rule 20, a platform model 60 can abstract the relevant features and functionality of lower-level operating systems or other computer-executable instructions that can provide information or support to the module. For ease of reference, the scenario model 50, the platform model 60, or combinations thereof, whatever may be relevant to the rule 20, can be referred to as the environment model 10. Thus, in the system 99 of FIG. 1, the environment model 10 can comprise both the scenario model 50 and the platform model 60, both of which can be used by the verification engine 40 to verify the module 30 with respect to the rule 20.

As described herein, the verification engine 40, the module 30, the rule 20 and the environment model 10, comprising the scenario model 40 and the platform model 60, can each comprise computer-readable instructions, computer-readable data, or combinations thereof. As such, although not required, the descriptions herein will be in the general context of computer-executable instructions, such as program modules, being executed by one or more computing devices. More specifically, the descriptions will reference acts and symbolic representations of operations that are performed by one or more computing devices or peripherals, unless indicated otherwise. As such, it will be understood that such acts and operations, which are at times referred to as being computer-executed, include the manipulation by a processing unit of electrical signals representing data in a structured form. This manipulation transforms the data or maintains it at locations in memory, which reconfigures or otherwise alters the operation of the computing device or peripherals in a manner well understood by those skilled in the art. The data structures where data is maintained are physical locations that have particular properties defined by the format of the data.

Generally, program modules include routines, programs, objects, components, data structures, and the like that perform particular tasks or implement particular abstract data types. Moreover, those skilled in the art will appreciate that the computing devices need not be limited to conventional personal computers, and include other computing configurations, including hand-held devices, multi-processor systems, microprocessor based or programmable consumer electronics, network PCs, minicomputers, mainframe computers, and the like. Similarly, the computing devices need not be limited to a stand-alone computing device, as the mechanisms may also be practiced in distributed computing environments where tasks are performed by remote processing devices that are linked through a communications network. In a distributed computing environment, program modules may be located in both local and remote memory storage devices.

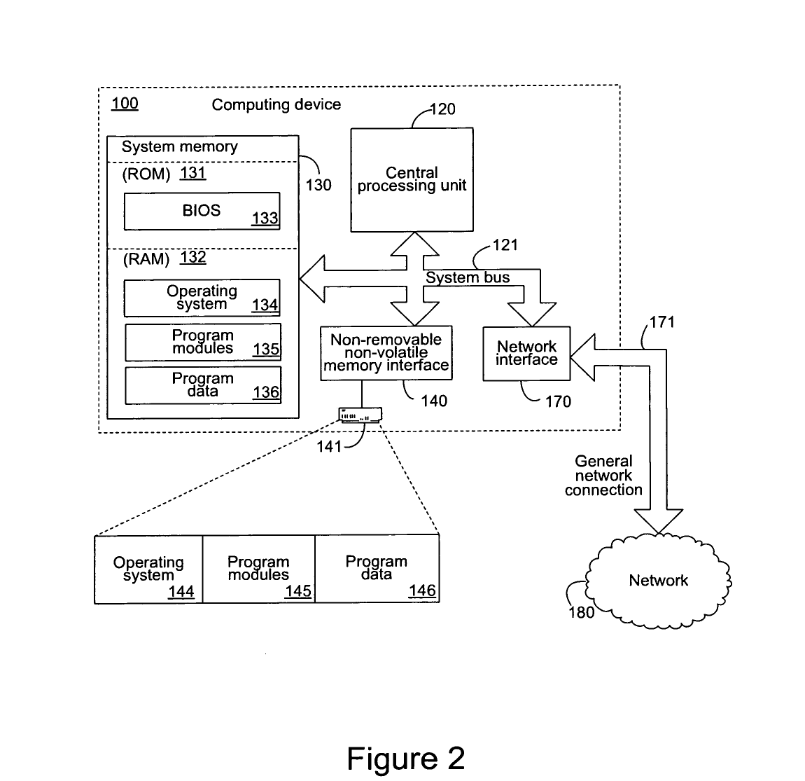

With reference to FIG. 2, an exemplary computing device 100 is illustrated, which can perform some or all of the actions attributed to the verification engine 40 of FIG. 1. The exemplary computing device 100 can include, but is not limited to, one or more central processing units (CPUs) 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures.

The computing device 100 also typically includes computer readable media, which can include any available media that can be accessed by computing device 100 and includes both volatile and nonvolatile media and removable and non-removable media. By way of example, and not limitation, computer readable media may comprise computer storage media and communication media. Computer storage media includes media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computing device 100. Communication media typically embodies computer readable instructions, data structures, program modules or other data in a modulated data signal such as a carrier wave or other transport mechanism and includes any information delivery media. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computing device 100, such as during start-up, is typically stored in ROM 131. RAM 132 typically contains data and/or program modules that are immediately accessible to and/or presently being operated on by processing unit 120. By way of example, and not limitation, FIG. 2 illustrates an operating system 134, other program modules 135, and program data 136.

The computing device 100 may also include other removable/non-removable, volatile/nonvolatile computer storage media. By way of example only, FIG. 2 illustrates a hard disk drive 141 that reads from or writes to non-removable, nonvolatile magnetic media. Other removable/non-removable, volatile/nonvolatile computer storage media that can be used with the exemplary computing device include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140.

The drives and their associated computer storage media discussed above and illustrated in FIG. 2, provide storage of computer readable instructions, data structures, program modules and other data for the computing device 100. In FIG. 2, for example, hard disk drive 141 is illustrated as storing an operating system 144, other program modules 145, and program data 146. Note that these components can either be the same as or different from operating system 134, other program modules 135 and program data 136. Operating system 144, other program modules 145 and program data 146 are given different numbers here to illustrate that, at a minimum, they are different copies.

Of relevance to the descriptions herein, the computing device 100 may operate in a networked environment using logical connections to one or more remote computers. For simplicity of illustration, the computing device 100 is shown in FIG. 2 to be connected to a network 180, which is not limited to any particular network or networking protocols. The logical connection depicted in FIG. 2 is a general network connection 171 that can be a local area network (LAN), a wide area network (WAN) or other network. The computing device 100 is connected to the general network connection 171 through a network interface or adapter 170 which is, in turn, connected to the system bus 121. In a networked environment, program modules depicted relative to the computing device 100, or portions or peripherals thereof, may be stored in the memory of one or more other computing devices that are communicatively coupled to the computing device 100 through the general network connection 171. It will be appreciated that the network connections shown are exemplary and other means of establishing a communications link between computing devices may be used.

Turning back to FIG. 1, a system comprising the verification engine 40 and collections of environment models, such as environment model 10, and collections of rules, such as rule 20, can be utilized to verify a range of modules, such as module 30. Some of the rules, such as rule 20, can be rather complex. For example, a complex rule can exist that specifies both whether a driver maintains power policy ownership and additionally in the case where the driver is a power policy owner, the rule can further specify proper power policy ownership behavior. A verification engine can fail to determine whether a driver adheres to such a complex rule. In such a case, a verification engine may generate a time out or other failure. Many complex rules, however, may be rewritten as a combination of simpler rules. Returning to the power policy ownership example, a first simpler rule, that will be referred to hereinafter as a “precondition rule”, can specify whether a driver maintains power policy ownership. A second simpler rule can specify proper power policy ownership behavior. A verification engine may be more likely to determine a result for both the first and the second simpler rule due to their simplicity. As a special case, in the case where a determination is made, based on the first rule, that a driver is not a power policy owner, there may not even exist a need to attempt to determine whether the driver adheres to the second rule.

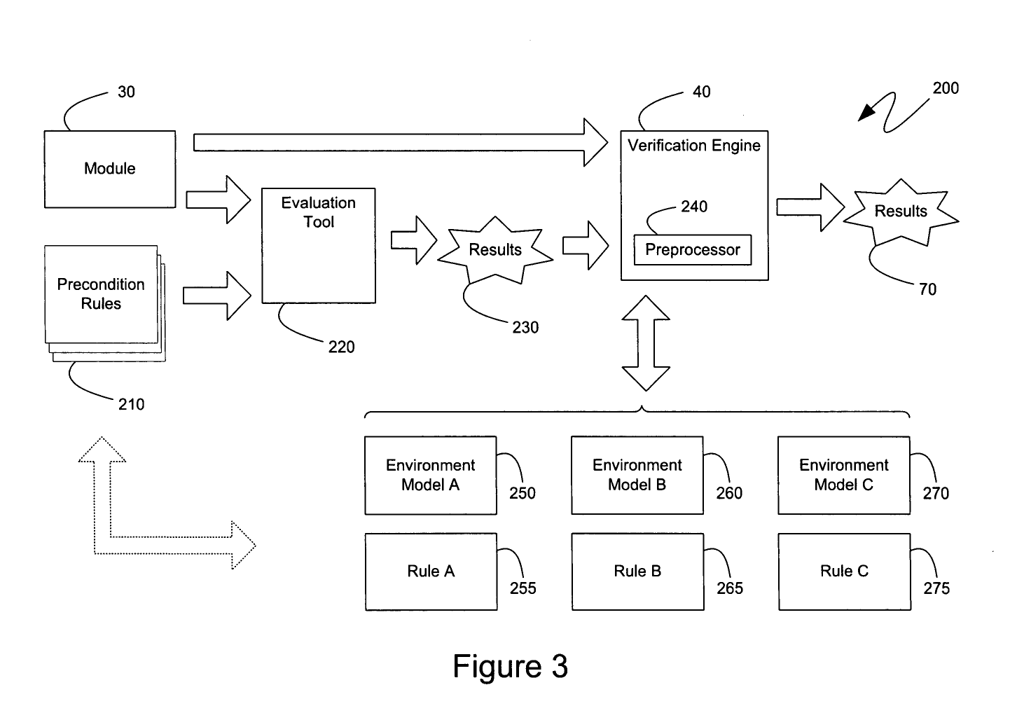

Turning to FIG. 3, system 200 illustrates the verification system 99 of FIG. 1 expanded to incorporate one or more such precondition rules 210. Generally, the module 30 can be evaluated by an evaluation tool 220 with respect to one or more of the precondition rules 210 to obtain information about the module 30, including its characteristics, features and functionality. The results 230 obtained by the evaluation tool 220, using the precondition rules 210, can be utilized by the verification engine 40 to identify those rules, such as rules 255, 265 and 275, that may, or may not, be applicable, to the module 30, thereby saving the verification engine from verifying the module 30 with respect to those rules that may be inapplicable. In one embodiment, the verification engine 40 can utilize a preprocessor 240 to evaluate the results 230 and select an appropriate “verification element”, with which the module 30 can be verified. The selected “verification element” can comprise one or more of the rules, 255, 265 and 275, one or more of the associated environment models 250, 260 and 270, a particular verification engine, such as the verification engine 40, or one or more input parameters to a given verification engine, such as a time limit after which the verification engine should cease the verification, or any combination or permutation thereof.

For ease of illustration and description, FIG. 3 shows the evaluation tool 220, preprocessor 240 and verification engine 40 as distinct entities. However, in one embodiment, a single verification entity can comprise the functionality of some or all of the evaluation tool 220, the preprocessor 240 and the verification engine 40. Consequently, the descriptions below are not meant to be limited to independent evaluation tools, preprocessors and verification engines. Similarly, while the evaluation tool 220 is illustrated as a different element than the verification engine 40, in one embodiment, the evaluation of precondition rules 210 performed by the evaluation tool can be equivalent to the evaluation of rules, such as rules 255, 265 and 275, performed by the verification engine. Consequently, none of the below descriptions are intended to imply that the precondition rules 210 must be of a different form than the rules 255, 265 and 275, and, indeed, in one embodiment, the precondition rules can be as complex, or even more complex, than the rules.

A particular rule, such as rule 20, can seek to verify a conformance to a particular guideline regarding the expected behavior of the module 30, conformance by the module 30 to particular specifications defining its interaction with external elements, conformance by the module 30 to specific coding conventions, or other similar issues. Because such guidelines, specifications, coding conventions and the like are often expressed in conditional form, a rule seeking to verify conformance to them can likewise often be conceptualized as a series of related rules that can be conditionally applied. For example, a simple guideline regarding the implementation of particular interfaces related to the power policy applied to a particular hardware device can be in a conditional form of: IF a module is a power policy owner for a particular device, THEN the module must implement particular interfaces related to power policy ownership. A slightly more complex variant of the same guideline can be in an alternative condition form of: IF a module is a power policy owner for a particular device, THEN the module must implement particular interfaces related to power policy ownership, AND IF a module is not a power policy owner for a particular device, THEN the module must be able to respond to particular instructions regarding the power policy of the device. A rule, such as rule 20, seeking to verify conformance with this exemplary guideline can be conceptualized as two related rules: the first rule seeking to verify implementation of the specified interfaces if the module 30 is the power policy owner for a particular device, and the second rule seeking to verify the module's ability to respond to the specified instructions if the module is not the power policy owner. Taken together, these two rules can be thought of as a single rule, such a rule 20, that verifies conformance to this exemplary guideline regarding power policy ownership.

Rule A 255, rule B 265 and rule C 275 illustrated in FIG. 3 can be representations of such component rules of an overall rule 20 from FIG. 1. Each of the component rules, such as rule A 255, rule B 265 and rule C 275, can be associated with a corresponding environment model, such as environment model A 250, environment model B 260 and environment model C 270, as shown in the system 200 of FIG. 3. For example, if rule A 255 was designed to verify conformance of the aspect of the exemplary power policy ownership guideline enumerated above that requires a module that is a power policy owner to implement specific interfaces, an associated environment model, such as environment model A 250, can comprise an abstraction of, for example, the operating system components that would utilize the required interfaces. Conversely, if rule B 265 was designed to verify conformance of the aspect of the same exemplary power policy ownership guideline that requires a module that is not a power policy owner to accept and respond to particular instructions, an associated environment model, such as environment model B 260, can comprise an abstraction of, for example, another module that would initiate or transmit the particular instructions. In such a manner, each environment model would comprise those elements that were relevant to the verification rule with which those environment models were associated.

In an alternative embodiment, rule B 265 and rule C 275 can merely be modified versions of rule A 255. Likewise, environment model B 260 and environment model C 270 can be modified versions of environment model A 250. Rule B 265 and rule C 275, as modified versions of rule A 255, need not be preexisting and can, instead, be generated after evaluation of the precondition rules 210. In such a manner, the selected rule can be modified based on the results of the evaluation of the precondition rules 210. Similarly, environment model B 260 and environment model C 270, as modified versions of environment model A 250, need not be preexisting and can, instead, be generated based on the evaluation of the precondition rules 210. In one embodiment, such a modification of rule A 255 into rule B 265 or rule C 275, or a modification of environment model A 250 into environment model B 260 or environment model C 270, can be performed by the preprocessor 240 or the verification engine 40 as part of the selection process described below.

The selection of a rule, such as rule A 255, rule B 265 and rule C 275, and potentially an associated environment model, such as environment model A 250, environment model B 260 and environment model C 270, with which the module 30 will be verified by the verification engine 40 can be informed by one or more precondition rules 210. Returning to the above-enumerated exemplary power policy ownership guideline, the precondition rules 210 can be directed to the determination of whether the module 30 is a power policy owner or not. For example, a precondition rule, such as precondition rule 210, can determine if the module 30 comprises the functionality expected from a power policy owner. If, using the precondition rule 210, the results 230 indicate that the module 30 is a power policy owner, then the environment model A 250 and the rule A 255, for example, can be selected by the verification engine 40 and it can verify the module 30 with respect to rule A. Alternatively, if, using the precondition rule 210, the results 230 indicate that the module 30 is not a power policy owner, then the environment model B 260 and the rule B 265, for example, can be selected by the verification engine 40 and it can verify the module 30 with respect to rule B. In such a manner, the precondition rules 210 can enable the selection of a subset of rules and, possibly, environment models as well by which the module 30 can be verified by the verification engine 40, thereby rendering the overall verification system 200 more efficient.

In one embodiment, the precondition rules 210 can be processed by an evaluation tool, such as the evaluation tool 220. Depending on the precondition rule 210, the evaluation tool 220 can process the precondition rule by referencing metadata associated with the module 30, by directly examining the module, including its structure, properties and even its behavior, or by performing other actions with respect to the module. As indicated previously, in one embodiment, the evaluation tool 220 can be no different than the verification engine 40 and can process the precondition rule in the same manner as the verification engine would process a rule, such as one or more of the rules 255, 265 and 275. The precondition rules 210 can be in the form of computer-executable instructions that can be understood by the evaluation tool 220 and can instruct the evaluation tool to determine information about the module 30. For example, a precondition rule 210 to determine if the module 30 is a power policy owner can comprise computer-executable instructions directing the evaluation tool 220 to determine if the module calls specific functions, or if the module itself comprises, and has the capability to respond to, specific types of functions.

In one embodiment, the precondition rules 210 can additionally comprise computer-executable instructions that can instruct the evaluation tool 220 to reach a conclusion, reflected in the results 230, based on the information obtained. For example, if the evaluation tool 220 determines that the module 30 comprises a specific type of function, the precondition rule 210 can comprise computer-executable instructions that can cause the evaluation tool to reach the conclusion that the module is not a power policy owner. In such an embodiment, the results 230 can indicate the conclusion that the module 30 is not a power policy owner. In an alternative embodiment, however, the results 230 can merely indicate the results of various determinations performed by the evaluation tool 220, as dictated by the precondition rules 210, leaving the ultimate evaluation of such results to the verification engine 40.

Irrespective of whether the results 230 comprise conclusions or mere evaluation data, they can be utilized by the verification engine 40 to select a rule, and possibly an associated environment model, with which the module 30 can be verified. In one embodiment, the verification engine 40 can utilize a preprocessor 240 that can evaluate conditional statements associated with the rules 255, 265 and 275, and with the environment models 250, 260 and 270, and can select an appropriate rule, and, if appropriate, a corresponding appropriate environment model, with which the module 30 can be verified by the verification engine 40.

Returning to the above example regarding an overall rule 20, designed to verify compliance with power policy ownership guidelines by the module 30, such a rule can, as indicated previously, be divided into a rule A 255, and an associated environment model A 250, that can be applicable if the module is a power policy owner and a rule B 265, and an associated environment model B 260, that can be applicable if the module is not a power policy owner. The results 230 from the evaluation tool 220 can, in one embodiment, indicate whether or not the module 30 is a power policy owner since, as indicated previously, the precondition rules 210 can have provided instructions for the evaluation tool 220 to obtain information about the module 30 relevant to the determination of whether the module is a power policy owner. In such an embodiment, the preprocessor 240 can evaluate a conditional statement that can specify that if the results 230 indicate that the module 30 is a power policy owner, then the preprocessor is to select rule A 255 and its associated environment model A 250 and if the results indicate that the module is not a power policy owner, then the preprocessor is to select rule B 265 and its associated environment model B 260.

In an alternative embodiment, the results 230 can comprise only the data obtained by the evaluation tool 220 without specific conclusions, such as whether the module 30 is a power policy owner. In such an embodiment, the precondition rules 210 may not have comprised relevant instructions by which the evaluation tool 220 can have reached a specific conclusion, or the evaluation tool may not have evaluated those relevant instructions even though they may have been present in the precondition rules. If the results 230 comprise merely data obtained by the evaluation tool 220, the preprocessor 240 can evaluate the conditional statements that can be contained in the precondition rules 210, or in another entity, such as header files, and can itself reach those conclusions that may be required for selection from among the rules 255, 265 and 275. For example, if the results 230 comprise an indication of whether or not the module 30 comprises a specific type of function, the preprocessor 240 can evaluate a conditional statement indicating that if a module comprises that type of function, then the module is not a power policy owner. The preprocessor 240 can, therefore, itself reach a conclusion, such as, for example, whether the module 30 is a power policy owner or not, and can then, in the manner described above, select from among the rules 255, 265 and 275, and associated environment models 250, 260 and 270.

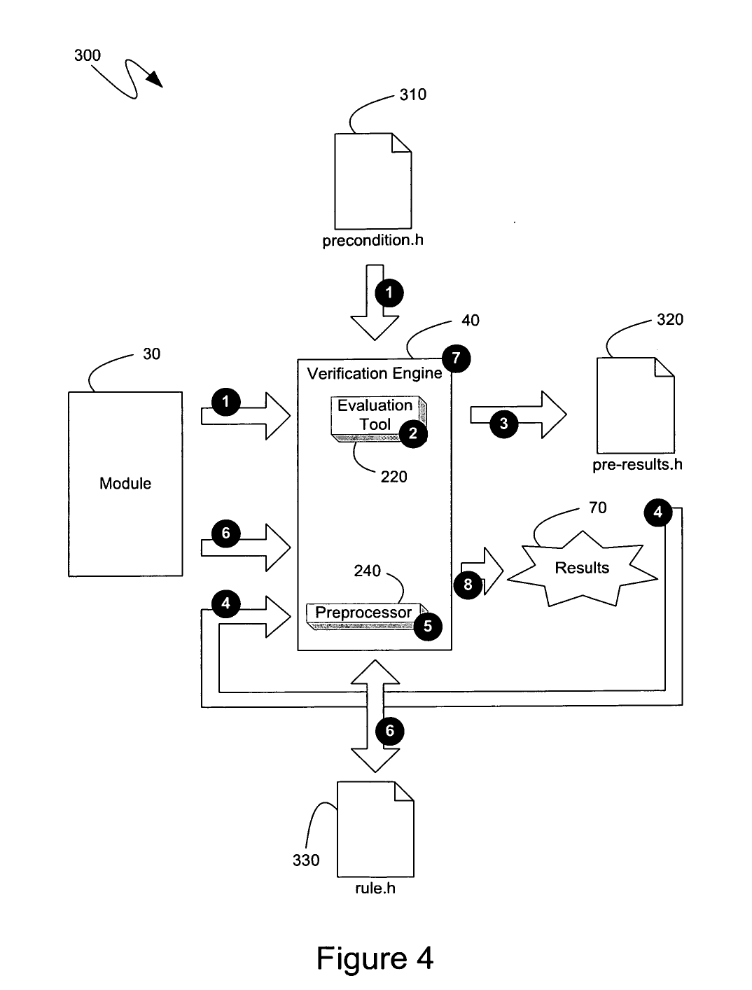

As indicated previously, the evaluation tool 220, preprocessor 240 and the verification engine 40 were shown in FIG. 3 as individual entities for ease of illustration. Turning to FIG. 4, a verification system 300 is illustrated having an evaluation tool 220 and preprocessor 240 as features of a verification engine 40. Indeed, in one embodiment, the evaluation tool 220 can be synonymous with the verification engine 40 in that the evaluation tool can evaluate a precondition rule in the same manner in which the verification engine evaluates a rule. In the verification system 300, the module 30 can be verified by the verification engine 40 with respect to a rule, such as rules 255, 265 and 275 of FIG. 3, which can each comprise a header file, such as the header file “rule.h” 330 of FIG. 4. In one embodiment, the header file “rule.h” 330 can comprise an indication of the applicability of the rule associated with the header 330. For example, a header file, such as header file 330, can indicate that its associated rule is applicable if the module 30 being verified is a power policy owner. If, therefore, the precondition rules cause module 30 to be identified as a power policy owner, the preprocessor 240 functionality of the verification engine 40 can reference the header file 330 and can, on account of the information contained in the header file, determine that the rule associated with the header file is to be used by the verification engine 40 to verify the module 30.

In the embodiment represented by the verification system 300 of FIG. 4, however, the verification engine 40 can not only identify with which rules the module is to be verified, but it can also process the precondition rules by which the rule selection can be informed. A header file, such as the “precondition.h” 310 header file, can list all of the precondition rules, such as precondition rules 210 of FIG. 3, that may need to be evaluated in order to inform the selection of an appropriate rule based on header files such as the “rule.h” 330 header file. The “precondition.h” 310 header file can be utilized by the verification engine 40 to provide precondition rules to the evaluation tool 220 functionality of the verification engine and thereby evaluate the module 30 in a manner equivalent to that described above. In one embodiment, the results, such as results 230 of FIG. 3, can be stored in a “pre-results.h” 320 header file. More particularly, the “pre-results.h” 320 header file can comprise the results of at least some, if not all, of the precondition rules listed by the “precondition.h” 310 header file.

In such a manner, the evaluation tool 220 functionality of the verification engine 40 can first perform a complete evaluation of the module 30, to the extent instructed by the precondition rules referenced in the “precondition.h” 310 header file, and the verification engine 40 can then utilize the preprocessor 240 functionality to select one or more rules with which the module 30 will be verified, based on the results contained in the “pre-results.h” 320 header file. Thus, as shown, the “pre-results.h” 320 header file can be provided back to the verification engine 40 to enable the preprocessor 240 functionality of the verification engine to reference the results contained in that header file, together with the requirements of one or more rules, as specified in rule header files, such as the “rule.h” 330 header file, to determine which rules should be used to verify the module 30. Once those rules are selected, the module 30 can be verified and the verification engine 40 can produce the results 70.

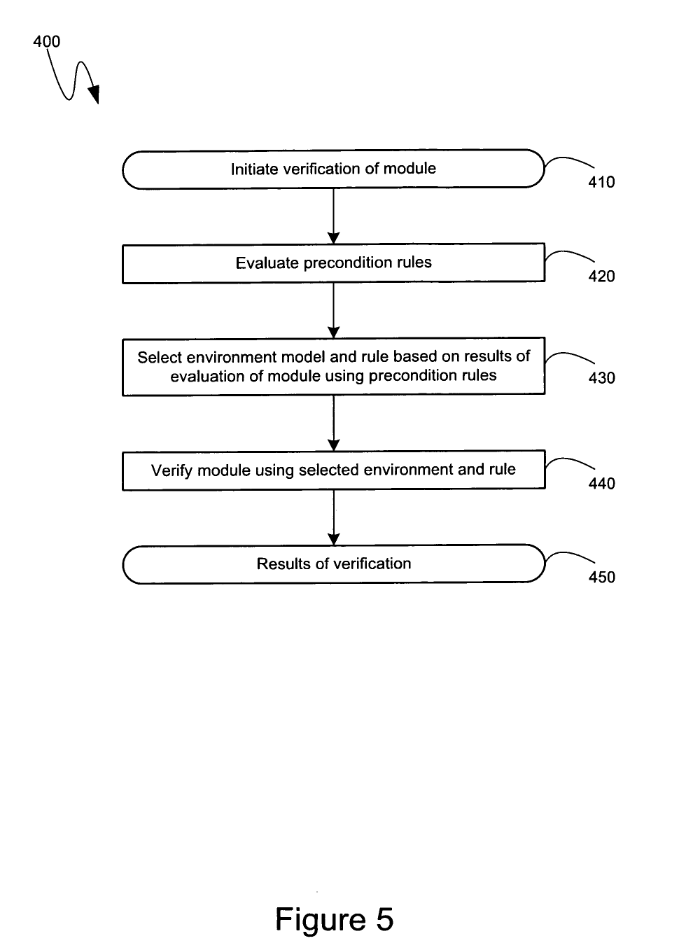

The flow diagram 400 of FIG. 5 illustrates one generalized process that can utilize the above-described precondition rule mechanisms. As shown, an initial step 410 can begin verification of a module, such as module 30. Subsequently, at step 420, precondition rules can be evaluated and information about the module can be obtained by the verification system. In one embodiment, step 420 can be performed by an evaluation tool 220, such as in the manner described above. The information about the module obtained at step 420 can, subsequently, be utilized at step 430 to select, based on that information, one or more rules, and potentially one or more associated environment models, with which the module will be verified. In one embodiment, step 430 can be performed by a preprocessor 240, such as in the manner also described above. Once the rules and environment models have been selected, the module can be verified, using the selected rules and environment models, at step 440 by the verification engine 40. The results of the verification can be provided at step 450, thus ending the relevant processing.

The evaluation of the precondition rules at step 420 can be performed in a straightforward manner if none of the precondition rules themselves have precondition rules. In such a case, evaluation of the precondition rules at step 420 can proceed in, for example, a linear fashion, with one precondition rule being evaluated after another, without regard to the order in which they are evaluated. However, if the precondition rules themselves have precondition rules, then the evaluation can utilize various mechanisms that are directed to multiple layers of precondition rules. While two such mechanisms are specifically illustrated and described below, the descriptions are meant to be exemplary only and are not meant to be limiting. Any mechanism by which a structure of related precondition rules is traversed in a logically consistent order can be utilized.

As indicated previously, a precondition rule, such as precondition rules 210 of FIG. 3, can provide computer-executable instructions to an evaluation tool, such as evaluation tool 220, to instruct the evaluation tool to obtain information regarding the module to be evaluated, such as module 30. In one embodiment, a precondition rule may only be applicable in specific circumstances. For example, returning to the above examples regarding a determination of whether the module 30 is a power policy owner, such a determination may only need to be made if the module is a driver module in the first place. Thus, in one embodiment, a precondition rule directed towards determining whether a module is a power policy owner or not can itself have a precondition rule directed to determining whether a module is a driver at all. In such a case the precondition rule to determine whether a module is a driver can be evaluated prior to the evaluation of a precondition rule to determine whether a module is a power policy owner, since the precondition rule to determine whether the module is a power policy owner may not need to be evaluated if the evaluation of the precondition rule to determine whether the module is a driver determines that the module is not a driver. Consequently, the precondition rule to determine whether the module is a driver can be considered a “lower level” precondition rule than the precondition rule to determine whether the module is a power policy owner, since it is a precondition rule to the precondition rule to determine whether the module is a power policy owner.

For ease of reference, precondition rule dependences can be ordered into “levels” such that a “first level” precondition rule can have no other precondition rules whose application is dependent on the results of the “first level” precondition rules. Similarly, a “second level” precondition rule can have its results be utilized to determine the applicability of a “first level” precondition rule. A precondition rule that itself has no precondition rules or, using the above terminology, has no levels of precondition rules below it, can be nominated a “terminal level” precondition rule. Of course, some “terminal level” precondition rules may be “first level” precondition rules, some may be “second level” precondition rules, and some may be even lower level precondition rules. Consequently, the “terminal level” need not refer to a particular level, per se, but rather can refer to the nature of the precondition rule itself, namely in not having any further precondition rules to it.

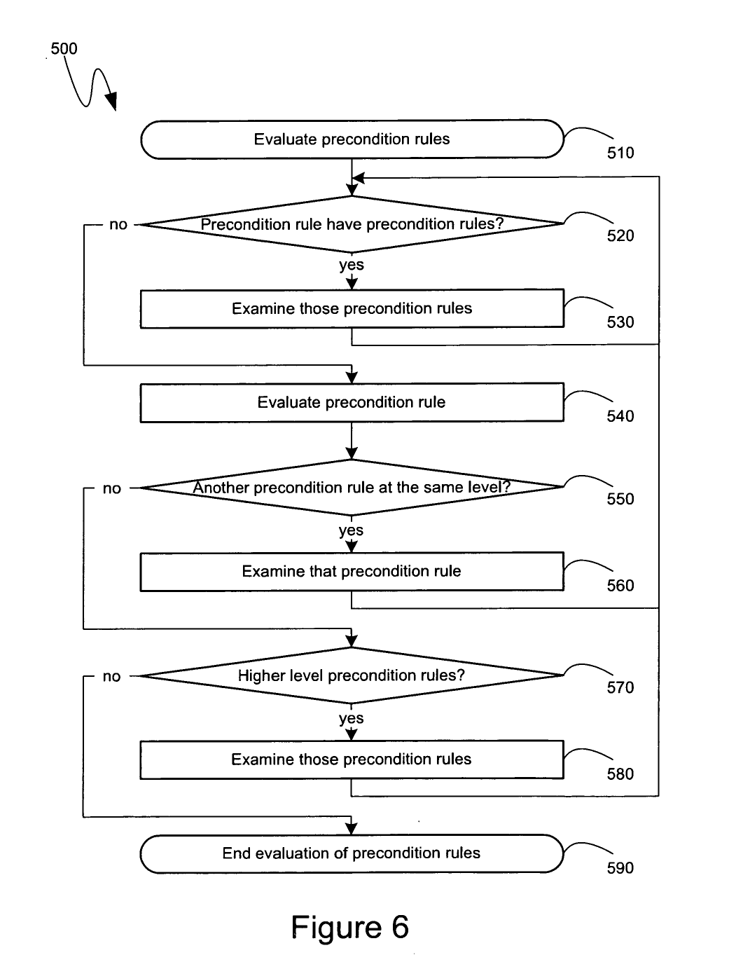

Turning to the flow diagram 500 of FIG. 6, one embodiment for evaluating multiple levels of precondition rules is illustrated. The mechanisms described with reference to the flow diagram 500 can be performed, such as by an evaluation tool 220, at step 420 of the flow diagram 400. Initially, at step 510, the evaluation of precondition rules can begin and a first precondition rule can be considered. At step 520 a determination can be made as to whether the precondition rule being considered itself has any precondition rules. If the precondition rule being evaluated does not itself have any precondition rules, processing can skip to step 540 at which point the precondition rule can be evaluated, such as in the manner described in detail above.

However, if, at step 520, it is determined that the precondition rule being considered itself has precondition rules, those precondition rules can be examined at step 530, thereby causing execution to return to step 520 and consider whether the precondition rule now being considered has precondition rules. As will be recognized by those skilled in the art, a net effect of the operation of steps 520 and 530 is that the evaluation step 540 will first be performed on a precondition rule that has no precondition rules or, to use the above terminology, is a “terminal level” precondition rule.

Subsequently, after such a terminal level precondition rule is evaluated at step 540, a check can be made at step 550 to determine if there is another precondition rule at that same level. If there is another precondition rule at the same level, that rule can be examined at step 560 in the same manner as just described with reference to steps 520 through 540, since, as indicated previously, the mere fact that the precondition rule now being examined at step 560 was at the same level as a precondition rule that was a “terminal level” precondition rule does not necessarily mean that the rule now being examined is, itself, a “terminal level” precondition rule.

Once all of the precondition rules at the same level have been examined, as determined by step 550, a determination can be made at step 570 if there are any higher level precondition rules. If there are, then at step 580 those higher level precondition rules can be examined in the same manner as described above with reference to steps 520 through 560. If, at step 570, it is determined that there are no higher level precondition rules, then the evaluation of the precondition rules can end at step 590.

As can be seen from the above descriptions, one of the net effects of the flow diagram 500 is to select a given “first level” precondition rule, drill down a particular dependency chain until a “terminal level” precondition rule is reached, evaluate that precondition rule, and then work back up the dependency chain, at each point drilling down another leg of the dependency chain in an equivalent manner. While flow diagram 500 can comprise multiple examination steps, such as steps 530, 560 and 580, it can also avoid evaluating precondition rules that are irrelevant. In particular, depending on the conditional statements associated with a precondition rule, some precondition rules can be definitively found to be relevant, or not relevant, to a particular module before all of the precondition rules of a lower level associated with that precondition rule have been evaluated. In such a case, because a definitive determination can already have been made, the remaining lower level precondition rules may not change the determination and can, therefore, be skipped, since they are no longer relevant.

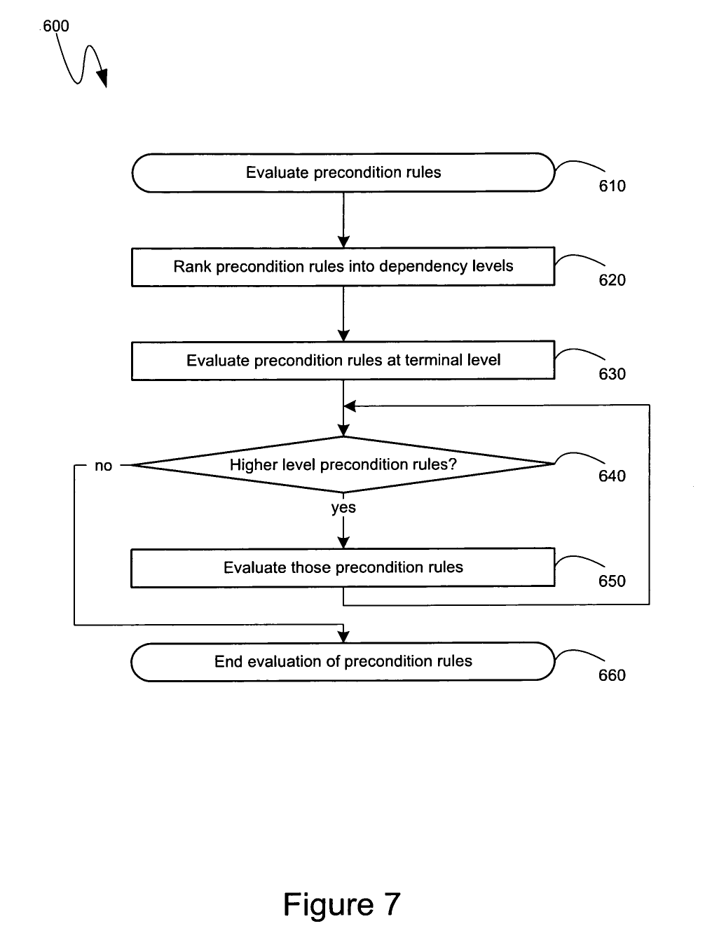

An alternative multi-level precondition rule evaluation mechanism is illustrated by flow diagram 600 of FIG. 7. Turning to FIG. 7, the flow diagram 600, like the flow diagram 500, can represent a way to perform the evaluation of precondition rules indicated by step 420 of FIG. 5. Thus, as with the initiating step 510 of flow diagram 500, the flow diagram 600 can begin with the commencement of the evaluation of the precondition rules as indicated by step 610. Unlike flow diagram 500, however, flow diagram 600 can proceed to a subsequent step 620 where the precondition rules are examined and ranked into dependency levels. As indicated previously, a “first level” precondition rule can be a precondition rule upon whose results no other precondition rules depend, a “second level” precondition rule can be a precondition rule upon whose results “first level” precondition rules depend, and so on. As also indicated previously, a “terminal level” precondition rule can be a precondition rule that does not itself have any further lower level precondition rules.

After at least some, if not all, of the precondition rules have been ranked into these types of dependency levels at step 620, the precondition rules at the “terminal level” can be evaluated at step 630. In performing the evaluation of the “terminal level” precondition rules at step 630, precondition rules belonging to different dependency chains can be evaluated sequentially without completing an evaluation of the dependency chain as would have been done by flow diagram 500. After the “terminal level” precondition rules are evaluated at step 630, a check can be made at step 640 for any higher level precondition rules. If there are higher level precondition rules found at step 640, they can then be evaluated at step 650. Subsequently, processing can return to the check at step 640 to determine if there are any even higher level precondition rules. Once “first level” precondition rules have been evaluated by step 650, and the check at step 650 determines that there are no further higher level precondition rules, the evaluation of the precondition rules can end at step 660.

The mechanisms of the flow diagram 600, as can be seen, may not drill down in the same manner as those illustrated in flow diagram 500 and, consequently, fewer examinations of the precondition rules may be performed. However, in some cases, the mechanisms shown in flow diagram 600 can evaluate precondition rules at lower levels that may turn out to have been irrelevant since a related higher level precondition rule can have been found to be inapplicable due to other lower level precondition rules. However, because each of the flow diagrams 500 and 600 illustrate mechanisms that have particular advantages, the selection of one such mechanism can be, in part, dictated by the types of precondition rules present in the verification system.

As can be seen from the above descriptions, mechanisms for providing precondition rules to verification rules have been provided. In view of the many possible variations of the subject matter described herein, we claim as our invention all such embodiments as may come within the scope of the following claims and equivalents thereto.

We claim:

1. One or more computer-readable media comprising computer-executable instructions for verifying a module, the computer-executable instructions directed to steps comprising:
evaluating a first precondition rule to obtain information about the module in accordance with the first precondition rule;
selecting, based on the obtained information about the module, a first verification element with which the module will be verified; and
verifying the module utilizing the first verification element.

2. The computer-readable media of claim 1, wherein the selecting the first verification element comprises selecting a first environment model with which the module will be verified.

3. The computer-readable media of claim 1, wherein the selecting the first verification element comprises selecting a first rule with which the module will be verified.

4. The computer-readable media of claim 3, wherein the first rule is associated with a first rule header file comprising a first conditional statement expressing whether the first rule should be selected as a function of at least the obtained information.

5. The computer-readable media of claim 1, wherein the selecting the first verification element comprises selecting a first verification engine that will be utilized to verify the module.

6. The computer-readable media of claim 1, wherein a second precondition rule is a precondition to the evaluating the first precondition rule.

7. The computer-readable media of claim 6, comprising further computer-executable instructions directed to evaluating precondition rules down a first dependency chain; returning to a higher level and evaluating precondition rules down a second dependency chain; and repeating the evaluating the precondition rules until there are no further dependency chains.

8. The computer-readable media of claim 6, comprising further computer-executable instructions directed to sorting at least some precondition rules with which the module is to be evaluated into dependency levels; evaluating precondition rules at a terminal level; evaluating precondition rules at a next higher level; and repeating the evaluating the precondition rules at the next higher level until there are no further higher levels.

9. A method for verifying a module comprising the steps of:
evaluating a first precondition rule to obtain information about the module in accordance with the first precondition rule;
selecting, based on the obtained information about the module, a first verification element with which the module will be verified; and
verifying the module utilizing the first verification element.

10. The method of claim 9, wherein the selecting the first verification element comprises selecting a first environment model with which the module will be verified.

11. The method of claim 9, wherein the selecting the first verification element comprises selecting a first rule with which the module will be verified.

12. The method of claim 11, wherein the first rule is associated with a first rule header file comprising a first conditional statement expressing whether the first rule should be selected as a function of at least the obtained information.

13. The method of claim 9, wherein the selecting the first verification element comprises selecting a first verification engine that will be utilized to verify the module.

14. The method of claim 9, wherein a second precondition rule is a precondition to the evaluating the first precondition rule.

15. The method of claim 14, further comprising the steps of: evaluating precondition rules down a first dependency chain; returning to a higher level and evaluating precondition rules down a second dependency chain; and repeating the evaluating the precondition rules until there are no further dependency chains.

16. The method of claim 14, further comprising the steps of: sorting at least some precondition rules with which the module is to be evaluated into dependency levels; evaluating precondition rules at a terminal level; evaluating precondition rules at a next higher level; and repeating the evaluating the precondition rules at the next higher level until there are no further higher levels.

17. A verification system for verifying a module of computer-executable instructions, the verification system comprising:
one or more precondition rules for obtaining information about the module in accordance with the one or more precondition rules;
an evaluation tool for evaluating the one or more precondition rules to obtain the information about the module in accordance with the one or more precondition rules;
one or more verification elements with which the module can be verified;
a preprocessor for selecting at least one verification element from among the one or more verification elements based on the obtained information about the module; and
a verification engine for verifying the module with the selected at least one verification element.

18. The verification system of claim 17, wherein the verification engine is the evaluation tool.

19. The verification system of claim 17, wherein the one or more precondition rules comprise multiple levels of precondition rules such that a first precondition rule at a lower level is a precondition rule to a second precondition rule at a higher level; and wherein further the evaluation tool evaluates precondition rules down a first dependency chain, returns to a higher level and evaluates precondition rules down a second dependency chain, and repeats the evaluating the precondition rules until there are no further dependency chains.

20. The verification system of claim 17, wherein the one or more precondition rules comprise multiple levels of precondition rules such that a first precondition rule at a lower level is a precondition rule to a second precondition rule at a higher level; and wherein further the evaluation tool sorts at least some precondition rules into dependency levels, evaluates precondition rules at a terminal level, evaluates precondition rules at a next higher level, and repeats the evaluating the precondition rules at the next higher level until there are no further higher levels.
